(19) United States
(12) Patent Application Publication
(10) Pub. No.: US 2025/0256750 A1
(43) Pub. Date: Aug. 14, 2025

(54) Baby's First Sports Car Stroller Device

(71) Applicant: Mary Ledford, Louisville, KY (US)

(72) Inventor: Mary Ledford, Louisville, KY (US)

(21) Appl. No.: 18/928,698

(22) Filed: Oct. 28, 2024

Related U.S. Application Data
(60) Provisional application No. 63/552,315, filed on Feb. 12, 2024.

(51) Int. Cl. B62B 5/00; B62B 9/10

(52) U.S. Cl. CPC B62B 5/0033; B62B 5/0069; B62B 9/10

(57) ABSTRACT

A motorized baby's sports car stroller device. The motorized baby stroller device comprises a body component that is configured in a rectangular shape and comprised of a frame, a body component, a handle, a windshield, a trunk, and at least one seat in the front and at least one seat in the back of the device. Removable seat covers increase the longevity and maintain the integrity of the device. The device accommodates infant car seats with the use of seat belts. Moreover, fidget toys are attached throughout the device to assist with reducing babies/toddlers stress, providing focus while parents or caretakers are shopping, and soothing babies. Specifically, the stroller device includes a temperature control element for the comfort of babies and toddlers. Further, the frame is secured to a plurality of large wheels designed to travel over a variety of terrains.

### CROSS-REFERENCE TO RELATED APPLICATION

The present application claims priority to, and the benefit of, U.S. Provisional Application No. 63/552,315, which was filed on Feb. 12, 2024, and is incorporated herein by reference in its entirety.

### FIELD OF THE INVENTION

The present invention relates generally to the field of baby strollers. More specifically, the present invention relates to an improved baby's first sports car stroller device. Accordingly, this disclosure makes specific reference thereto the present invention. Nonetheless, it is to be appreciated that aspects of the present invention are also equally applicable to other like applications, devices and methods of manufacture.

### BACKGROUND

By way of background, this invention relates to improvements in baby stroller devices. Generally, transporting a baby or toddler can be challenging for parents or caretakers. Further, transporting multiple babies or toddlers can be especially difficult for parents, grandparents, or caretakers. Specifically, going to the grocery store, tending to daily errands, attending a theme park, visiting family and friends, or simply strolling through a community park with more than one child can be overwhelming. Users need an easier way to perform basic daily errands or enjoy a day at the park without trying to balance carrying babies, toddlers, shopping bags, and necessary personal items.

Further, after driving to the store, park, or other destination, users may be unable to find parking near an entrance and it may be a considerable distance from the front door or actual location selected for the day's outing. Often, a long walk across a parking lot is required or walking through a theme park may be particularly burdensome when handling a combination of babies, personal items, shopping bags, and other paraphernalia for the daily outing. Without a baby stroller or similar device to accommodate multiple children and items, the user frequently makes several trips or is unable to complete the errands in a timely fashion. However, most baby strollers have limited space to accommodate multiple children, shopping bags, personal items, or other paraphernalia needed for the day.

Accordingly, there is a demand for an improved baby stroller device that provides a motorized stroller to accommodate multiple babies and storage space for backpacks, shopping bags, personal items and more. More particularly, there is a demand for a motorized baby stroller device that replicates the appearance of a sports car and is collapsible for easy transport/storage.

Therefore, there exists a long felt need in the art for a motorized baby stroller device that provides users with a motorized stroller for transporting multiple babies and/or toddlers. There is also a long felt need in the art for a motorized baby stroller device that comprises a trunk area for additional storage. Further, there is a long felt need in the art for a baby stroller device that has a rechargeable motor. Moreover, there is a long felt need in the art for a device that can be pushed manually or driven by a remote control. Further, there is a long felt need in the art for a stroller that has a metal frame and designed to look like a sports car. Moreover, there exists a long felt need in the art for a baby stroller that has a retractable roof, doors, and a windshield for protection against inclement weather and potential bug bites from insects, such as bees, mosquitos, or other insects. There also exists a long felt need in the art for a baby stroller device that provides heat or air conditioning for added comfort for the children in the baby stroller device. Further, there exists a long felt need in the art for a baby stroller that seats up to three toddlers or children and accommodates infant car seats and bottles or beverages. Moreover, there is a long felt need in the art for a motorized baby stroller designed with wheels that can be used on various terrains. Further, there is a long felt need in the art for a motorized baby stroller device that is collapsible for easy transport and storage. Finally, there is a long felt need in the art for a motorized stroller device that can be manufactured in a plurality of colors and models to meet individual demands and preferences.

The subject matter disclosed and claimed herein, in one embodiment thereof, comprises a baby's first sports car stroller device. The device is a multipurpose, motorized baby stroller for easily transporting backpacks, shopping bags, snacks or additional items over a variety of terrains. The motorized baby sports car stroller device comprises a body component that is configured in a rectangular shape and comprised of a frame, seats, retractable roof, handle for manual pushing, trunk for storage, and cupholders for the babies, toddlers and users. The base component comprises a plurality of play fidget items to pacify and occupy babies and toddlers while in the device. The device can be constructed of a strong durable plastic material that makes sanitizing simple and safe. The frame is secured to a plurality of large wheels designed to travel over a variety of terrains. Further, the frame and handle comprise a battery-operated motor which is rechargeable for remote operation, or the device can be operated manually.

In this manner, the baby's first sports car stroller device of the present invention accomplishes all of the forgoing objectives and provides users with a device that provides a motorized stroller that accommodates multiple babies or toddlers for daily use, the park, the beach, or visiting family and friends. The device has a battery-operated motor and large wheels for traveling on a variety of terrains. The device can be collapsed for storage/transport.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a motorized baby's first sports car stroller device. The device is a multipurpose, motorized baby stroller for easily transporting babies, supplies, bags, and personal items to go shopping, on daily errands, or for pleasure over various terrains. The motorized baby sports car stroller device comprises a body component that includes a frame, seats, retractable roof, umbrella, handles for manual pushing, trunk for storage, cupholders for the babies, toddlers, and users. The frame is secured to a plurality of large wheels designed to travel over a variety of terrain. Further, the frame and handle comprise a battery-operated motor which is rechargeable for remote operation, or the device can be operated manually.

The present invention is directed to a motorized baby's sports car stroller device that has particular utility in transporting shopping bags and personal items, such as groceries, diapers, bottles, snacks, and other paraphernalia, etc. In the present invention, the motorized baby stroller device can be steered and easily pushed at a comfortable walking speed of the user. Although the device is manually steerable, the device adapts to various terrains, such as a parking lot surface, pavement, soft sand, and hard sand, etc. Accordingly, the baby stroller device has large wheels with treaded tires, a handle for steering, and a rechargeable motor, to allow transport of multiple babies or toddlers on a variety of terrains and elevation changes, enabling high control of the stroller device and little pushing effort by the user.

In one embodiment, the motorized baby's sports car stroller device comprises a body component that is configured in a rectangular shape, but can be any suitable shape and size as is known in the art. The body component comprises a frame, body component, at least one seat, retractable roof, handlebar for manual pushing, trunk for storage, at least one cupholder for the babies, toddlers, and users. The frame is typically manufactured from a metal material, such as aluminum or steel, but could also be manufactured of a durable plastic, as well. The frame comprises a plurality of rods and struts which are configured to form a rectangular frame for the device with a weight bearing center bar to accommodate the multiple babies or toddlers. Thus, the frame can be expanded into an elongated rectangular configuration during use or collapsed together for storage. In other words, in the collapsed mode, the size and/or the volume occupied by the device is significantly reduced, thereby facilitating efficient storage and ease of transport. Further, the frame can be locked and unlocked in either position (i.e., collapsed and expanded).

In one embodiment, the seats are attached and secured to the frame of the sports car stroller device. Typically, the at least one seat is in the front of the device and at least one seat is in the back of the device. Further, the seats are secured to the frame of the device via brackets, buckles, pivot pins, etc., or any other suitable securing means as is known in the art. Specifically, the seat can be in an upright position, recline, or swivel using an adjustable motion system.

In yet another embodiment, the stroller device comprises at least one lap belt for each seat in the device. The seat belts, preferably manufactured from a durable fabric such as but not limited to a polyester or nylon webbing. Moreover, the seat belt is secured with a fastener such as but not limited to a buckle system, which secures and releases the tongue, which is attached to the webbing. Further, the seats in the stroller device can be manufactured to accommodate infant and toddler car seats. Generally, infant car seats are secured to the seat in the device using a seat or lap belt.

In one embodiment, the stroller device comprises a plurality of removable seat covers. The seat covers, preferably manufactured from a durable fabric such as but not limited to nylon, polyester, or any suitable fabric as is known in the art. Typically, babies and toddlers do not have fully developed fine motor skills and can be clumsy, therefore spilling and dropping bottles, drinks, snacks and other food particles. Further, the removable seat covers are machine washable to maintain and increase the longevity of the covers. Moreover, the removable seat covers are secured via a fastener such as but not limited to zippers, snaps, straps, hooks, or suitable mechanism as is known in the art.

In one embodiment, the stroller device comprises a plurality of cupholders/bottle holders located near each seat in the device. The cupholders/bottle holders are preferably manufactured from a durable plastic material such as but not limited to polypropylene or polyethylene. Further, polypropylene and polyethylene are durable materials that are safe for children. Finally, a durable plastic material is easy to clean with the number of anticipated spills occurring.

In one embodiment, the stroller device comprises a plurality of fidget toys attached to the dashboard of the device and the back side of at least one of the front seats. Specifically, fidget toys such as but not limited to fidget spinners, fidget cubes, rubber balls are located throughout the interior of the device as soothing, stress and anxiety reduction, and increased focus and concentration tools. Preferably, the fidget toys are attached to the interior of the device via child safety fasteners such as but not limited to straps, hooks, snaps, or any suitable fastener as is known in the art.

In one embodiment, the motorized baby's first sports car stroller device comprises a plurality of wheels secured via axles to the frame. The wheels can be any suitable number and shape and size as is known in the art. Typically, the device comprises four wheels, with one wheel secured to each corner of the frame. Specifically, the frame comprises a front axle and a rear axle with a set of wheels secured to each axle via a simple nut and bolt threaded connection. The wheels are large enough to displace up to approximately 120 pounds of weight during use. Further, the wheels are typically large wheels with large tire treads for stability and to help the device move through a variety of terrains during use.

In one embodiment, the motorized baby stroller device comprises a handlebar that is attached to the top of the trunk of the sports car stroller device. The handlebar component connects to a steering linkage assembly, and the steering linkage assembly connects to the frame and the front wheels. The steering linkage assembly is preferably made of, but not limited to, aluminum or steel. The linkage assembly is preferably configured, but not limited to, synchronized swivels above each wheel or a pinned connection to the front axle. The handle with the steering linkage assembly allows a user to steer the device, while in use. The handle can be any suitable shape and size as is known in the art, as long as the handle is long enough to allow a user to easily push the device while walking. Preferably, the handlebar is manufactured from but not limited to a durable plastic for ease of cleaning. Further, the handlebar also comprises at least one cup holder for the adult user of the device. Moreover, the handlebar component includes a receptacle for the umbrella component that can be attached or removed to the according to the weather or users preferred comfort level. In one embodiment, the handle can also comprise a textured grip area for non-slip grip and/or a grip section for added comfort while pushing the device.

In one embodiment, the handle comprises a battery for powering the device. The battery is typically positioned in the body of the handle but can be in any suitable position on the handle or the device as is known in the art. The battery is a rechargeable battery and is typically a USBC rechargeable battery for powering an electric motor.

In one embodiment, the handle comprises a remote control, which is a throttle button or on/off switch for turning on and off the attached motor. In another embodiment, the handle also comprises a forward/backward switch, as well as the on/off switch (i.e., throttle switch) to control the movement of the device during use. In yet another embodiment, the remote control comprises a switch or knob to regulate the temperature in the device while in use.

In one embodiment, the device comprises at least one motor that connects to a drive assembly, and the drive assembly connects to the front and rear wheels. Preferably, the motor is a DC motor powered by the battery, which allows the motor to be rechargeable. Typically, the electric motor is in mechanical communication with the drive assembly and attached wheels to drive the wheels. Any suitable number of electric motors can be used to drive the device during use and the motors can be positioned in any suitable place on the device. Further, the motor, the battery, and the controller are all in electrical communication with each other to move the device. The motor, battery, and controller, as well as the throttle switches are all configured to fit within the handle or the device. However, options are available for wired or wireless controls, as well.

In one embodiment, the baby's first sports car stroller device comprises a retractable roof. Typically, the retractable roof is manufactured from a durable fabric such as but not limited to polyester, polyacrylic, vinyl, canvas or any suitable fabric as is known in the art. In yet another embodiment, the rooftop is secured to the device via at least one fastener such as but not limited to buckles, straps, snaps or any suitable fastener as is known in the art. Further, in a retracted state, the rooftop is collapsed and placed in the trunk of the device for storage.

In one embodiment, the device comprises a trunk for storage. The trunk is positioned at the rear of the stroller device. The handle is located on top of the trunk and used a leverage to open the trunk. In yet another embodiment, the device may be manufactured with a lock system to secure shopping bags or personal items stored in the trunk of the stroller device.

In one embodiment, the device comprises a windshield. The windshield, located at the front of the device is preferably manufactured from a durable plastic such as but not limited to acrylic, polycarbonate, or suitable plastic as is known in the art. Further, acrylic and polycarbonate are light weight, durable, impact resistant and may be easily formed into a variety of sizes and shapes. Typically, the windshield serves to protect babies and toddlers from inclement weather and potential bug bites from flying insects.

In yet another embodiment, the device comprises at least one side window. The side window, located on at least one door on the baby's first sports car stroller device. The window is preferably manufactured from a durable plastic such as but not limited to acrylic, polycarbonate, or suitable plastic as is known in the art. Further, acrylic and polycarbonate are light weight, durable, impact resistant and may be easily formed into a variety of sizes and shapes. Finally, the window protects babies and toddlers from inclement weather and potential bug bites from flying insects.

In one embodiment, the motorized baby's first sports car stroller device comprises a body component manufactured in the shape of a sports car. The body component is preferably manufactured from a durable plastic such as but not limited to polyethylene, polypropylene, polyvinylchloride, or suitable plastic known in the art. Further, the body component of the sports car stroller device may be manufactured in a variety of sizes and colors to meet the users desired preference.

In yet another embodiment, the motorized baby's first sports car stroller device comprises a plurality of indicia.

In yet another embodiment, a method of easily transporting babies, toddlers, personal items, and shopping bags is disclosed. The method includes the steps of providing a motorized baby's first sports car stroller device comprising a body component with a frame, outer shell, seats, handle, and an umbrella. The method also comprises securing infant car seats to device seats. The method comprises securing babies or toddlers into the device seats. The method also comprises pushing the device manually. The method also comprises utilizing the handle, battery-operated motor, heat/AC and large wheels to easily transport babies, toddlers, shopping bags, supplies and gear to the store or park. The method comprises retracting the roof up or down. The method also includes attaching the umbrella to the handle. The method also includes placing personal items in the trunk for storage. The method comprises removing the seat covers for cleaning and storage. Finally, the method comprises collapsing the frame for storage.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one embodiment of the motorized baby's first sports car device of the present invention showing the rechargeable battery removed in accordance with the disclosed architecture;

FIG. 2 illustrate a perspective view of one embodiment of the motorized baby's first sports car device of the present invention showing how it can be collapsed in accordance with the disclosed architecture;

FIG. 3 illustrate a perspective view of one embodiment of the motorized baby's first sports car device of the present invention showing the device expanded and collapsed in accordance with the disclosed architecture; and

FIG. 4 illustrates a flowchart showing the method of easily transporting babies, toddlers, supplies and gear to the store or park in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long felt need in the art for a motorized baby stroller device that provides users with a motorized stroller for transporting multiple babies and/or toddlers to the store, park, or to visit family and friends. There is also a long felt need in the art for a motorized baby stroller device that comprises a trunk area for additional storage. There is also a long felt need in the art for a motorized baby stroller device that comprises large wheels designed to travel over a variety of terrains. Further, there is a long felt need in the art for a baby stroller device that has a rechargeable motor. Moreover, there is a long felt need in the art for a device that can be pushed manually or driven by a remote control. Further, there is a long felt need in the art for a stroller that has a metal frame and designed to look like a sports car. Moreover, there exists a long felt need in the art for a baby stroller that has a retractable roof, doors, and a windshield for protection against inclement weather and potential bug bites from insects, such as bees, mosquitos, or other insects. There also exists a long felt need in the art for a baby stroller device that provides heat or air conditioning for added comfort for the children in the baby stroller device. Further, there exists a long felt need in the art for a baby stroller that seats up to three toddlers or children and accommodates infant car seats and bottles or beverages. Further, there is a long felt need in the art for a motorized baby stroller device that is collapsible for easy transport and storage. Finally, there is a long felt need in the art for a motorized stroller device that can be manufactured in a plurality of colors and models to meet individual demands and preferences.

The present invention, in one exemplary embodiment, is a novel motorized baby's sport car stroller device. The motorized baby stroller device comprises a body component that is configured in a rectangular shape and comprised of a frame, body component seats, retractable roof, handle, trunk, cup holders, adjustable seats, removable seat covers, and fidget toys. The frame is secured to a plurality of large wheels designed to travel over a variety of terrains. Further, the frame and handle comprise a battery-operated motor which is rechargeable and a throttle button. Moreover, the retractable roof, climate control, adjustable seats, and fidget toys provide enhanced comfort for the babies and toddlers in the stroller device. The present invention also includes a novel method of easily transporting babies, toddlers, supplies and gear to the store or park. The method includes the steps of providing a motorized baby stroller device comprising a body component with a frame, body component, seats, roof, windows, handles, and trunk. The method also comprises securing babies and toddlers into the device using seat belts. Further, the method comprises pushing the device manually. The method also comprises utilizing the handle, battery-operated motor, and large wheels to easily transport babies and toddlers to the store or park. The method comprises retracting the roof up or down. The method also includes attaching the umbrella to the handle. The method also includes placing personal items in the trunk for storage. The method comprises removing the seat covers for cleaning and storage. Finally, the method comprises collapsing the frame for storage.

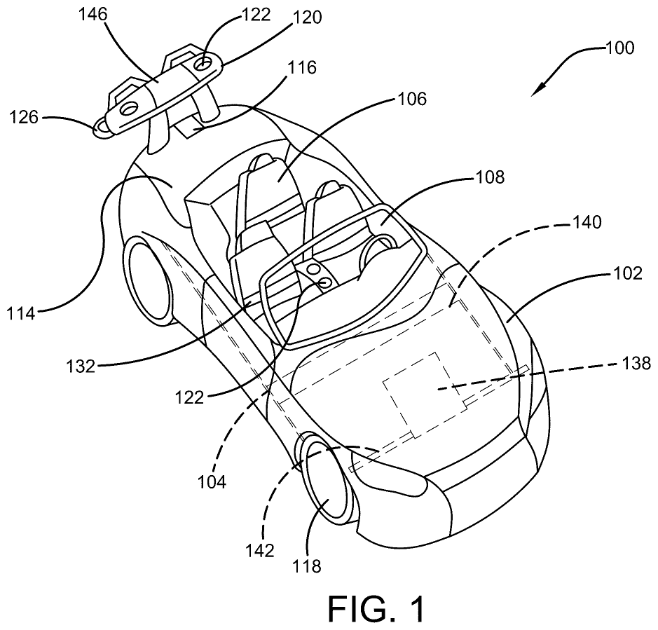

Referring initially to the drawing, FIG. 1 illustrates a perspective view of one embodiment of the baby's first sports car stroller device 100 of the present invention. The device 100 comprises an improved motorized baby stroller that provides a user 10 with a multipurpose, motorized stroller for transporting multiple babies/toddlers 20 and necessities to the store, park, or to visit family and friends.

The motorized baby stroller device 100 comprises a body component 102 with a frame 104, at least one seat 106, and at least one seat belt 132. The frame 104 is typically made of metal, such as aluminum or steel, but could also be manufactured of a durable plastic. The frame 104 configured to form a rectangular frame for the device 100 with a weight-bearing center bar 140 to accommodate up to 120 pounds of weight. The device 100 securely accommodates infant car seats with at least one lap/seat belt 132.

The body component 102 is configured in a rectangular shape but can be any suitable shape and size. The body 102 also includes removable seat covers 128 that protect the seat 106 components. These seat covers 128 are machine washable and easily removed and reattached with fasteners 130, such as snaps, zippers, or buckles, increasing the longevity of the fabric. The body component 102 and removable seat covers 128 may be manufactured in a variety of colors and may include at least one indicia 158.

The body component 102 may resemble any style of vehicle and includes a trunk 114 with a lock 116 for storage. The body component 102 also includes a windshield 108, windows 110 on either side, and a retractable rooftop 112 to protect babies/toddlers from inclement weather or extreme sun. The motorized stroller device 100 can be operated manually or electronically. The device 100 includes a remote control 152 with a throttle switch 154 and a forward/backward button 156. The remote control 152 also includes a heating/AC knob 136, allowing users 10 to control the climate inside the device 100 when the windows 110 and rooftop 112 are closed via at least one heating and cooling unit 141.

The stroller has at least one wheel 118 attached to the frame 104, enabling the device to travel over various terrains. The wheels 118 are typically large and treaded to help the device move across different surfaces, such as parking lots, pavement, and park trails. The wheels 118 are connected to the frame 104 via axles 142 and can support up to 120 pounds. The wheels 118 are secured using a nut and bolt threaded connection.

The handlebar 120 is attached to the trunk 114 and is used by the user 10 to manually steer the device 100. The handlebar 120 includes a textured grip area 146 for ease and comfort, a cup holder 122, and a receptacle 126 for an umbrella 124. It also connects to a steering linkage assembly 144, which in turn connects to the frame 104 and the front wheels 118. This assembly, typically made of aluminum or steel, allows the user 10 to steer the device 100, with synchronized swivels or pinned connections for the front axle 142.

In one embodiment, the device 100 is equipped with a rechargeable battery-operated motor 138 that connects to a drive assembly 148, which drives the front and rear wheels 118. The motor 138, typically a DC motor powered by a battery 150, is in mechanical communication with the drive assembly 148. The motor, battery, and controller 152 are in electrical communication and can be housed in the handle 120 or elsewhere on the device 100. The battery 150 is rechargeable, typically via USB-C, and is housed either in the body of the handle 120 or elsewhere on the device 100. The handle 120 includes a controller 152, throttle button 154, and on/off switch for controlling the movement of the device 100. The handle 120 may also include a forward/backward switch 158 for additional control.

The motorized baby stroller device 100 is designed for easy pushing at a comfortable walking speed for the user 10. It adapts to various terrains and elevation changes, requiring little pushing effort. The inclusion of multiple fidget toys 134 such as fidget spinners, cubes, and rubber balls throughout the interior of the device provides entertainment for babies/toddlers 20, helping to soothe, reduce stress, and increase focus.

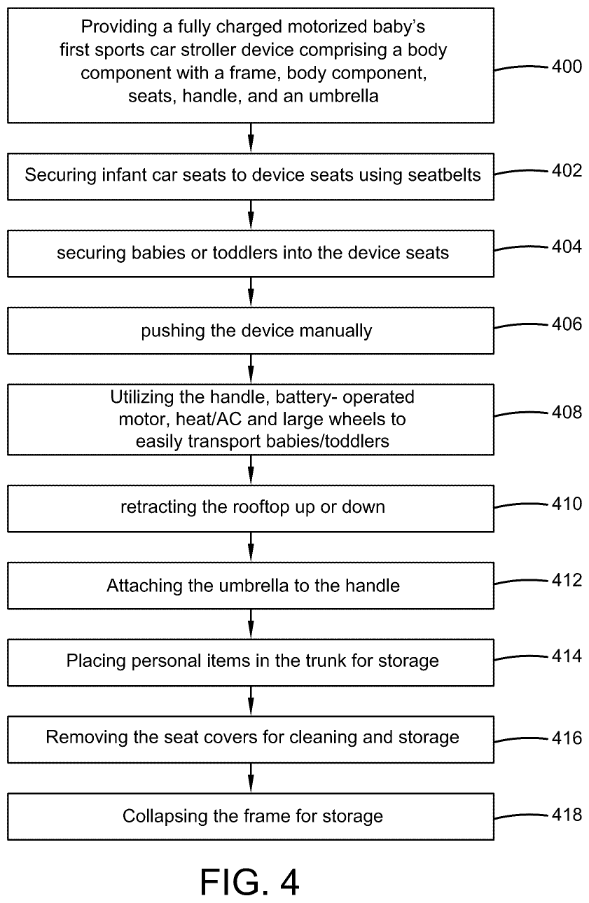

FIG. 4 illustrates a flowchart of the method of easily transporting babies/toddlers, supplies and personal items to run errands or visit a park. The method includes the steps of at 400, providing a fully charged motorized baby's first sports car stroller device comprising a body component with a frame, body component, seats, handle, and an umbrella. The method also comprises at 402, securing infant car seats to device seats using seatbelts. Further, the method comprises at 404, securing babies or toddlers into the device seats. The method also comprises at 406, pushing the device manually. The method also comprises at 408 utilizing the handle, battery-operated motor, heat/AC and large wheels to easily transport babies, toddlers, shopping bags, supplies and gear to the store or park. The method also comprises at 410 retracting the rooftop up or down. The method also comprises at 412 attaching the umbrella to the handle. The method also comprises at 414 placing personal items in the trunk for storage. The method also comprises at 416 removing the seat covers for cleaning and storage. Finally, the method comprises at 418 collapsing the frame for storage.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “motorized baby stroller device”, “baby's first sports car stroller device”, “stroller device”, and “device” are interchangeable and refer to the baby's first sports car stroller device 100 of the present invention.

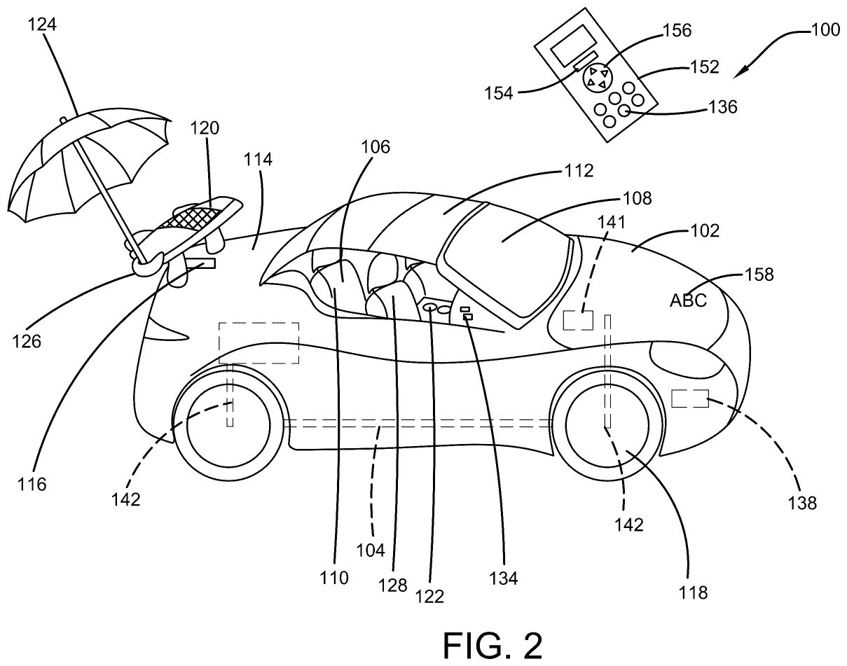

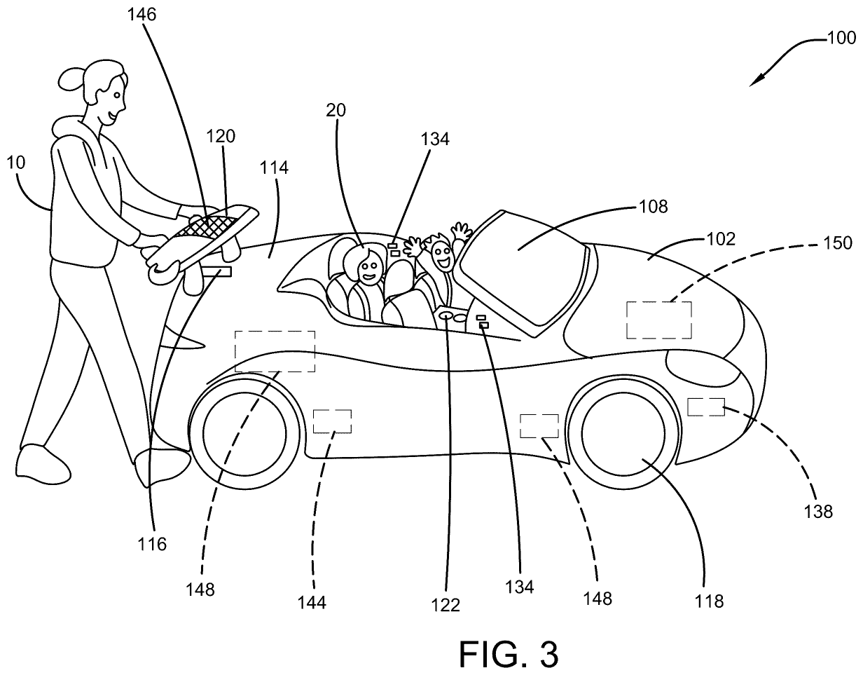

Notwithstanding the forgoing, the baby's first sports car stroller device 100 of the present invention can be of any suitable size and configuration as is known in the art without affecting the overall concept of the invention, provided that it accomplishes the above stated objectives. One of ordinary skill in the art will appreciate that the motorized baby stroller device 100 as shown in FIGS. 1-4 is for illustrative purposes only, and that many other sizes and shapes of the motorized baby stroller device 100 are well within the scope of the present disclosure. Although the dimensions of the motorized baby stroller device 100 are important design parameters for user convenience, the motorized baby stroller device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A motorized baby stroller device comprising:
a vehicle body comprised of a frame;
a seat disposed on the frame;
a seat belt;
a wheel connected to the frame;
a handle attached to the body;
a rechargeable battery-powered motor in mechanical communication with a drive assembly for driving the wheel; and
a remote control comprised of a throttle switch, a forward control, and a backward control.

2. The motorized baby stroller device of claim 1, wherein the seat is comprised of a cover.

3. The motorized baby stroller device of claim 1 further comprised of a retractable rooftop.

4. The motorized baby stroller device of claim 1 further comprised of a heating and cooling unit.

5. The motorized baby stroller device of claim 1, wherein the handle is comprised of a cupholder.

6. The motorized baby stroller device of claim 1, wherein the handle is comprised of a textured grip.

7. The motorized baby stroller device of claim 1, wherein the vehicle body is comprised of a window.

8. The motorized baby stroller device of claim 1, wherein the vehicle body is comprised of a windshield.

9. The motorized baby stroller device of claim 1, wherein the body is comprised of a trunk.

10. The motorized baby stroller device of claim 9, wherein the trunk is comprised of a lock.

11. A motorized baby stroller device comprising:
a frame configured to form a rectangular structure, the frame comprised of a weight-bearing center bar;
a seat disposed on the frame, the seat comprised of a seat cover;
a wheel connected to the frame via an axle;
a handlebar attached to the frame, the handlebar comprised a steering linkage assembly for manually steering the wheel;
a trunk comprised of a lock;
a retractable rooftop; and
a battery-operated motor connected to a drive assembly for propelling the motorized baby stroller device.

12. The motorized baby stroller device of claim 11, wherein the wheel is comprised of a treaded wheel.

13. The motorized baby stroller device of claim 11, wherein the seat cover attaches to the seat via a fastener.

14. The motorized baby stroller device of claim 11, wherein the steering linkage assembly attaches to the axle.

15. The motorized baby stroller device of claim 11, wherein the battery-operated motor is comprised of a DC motor.

16. The motorized baby stroller device of claim 11, wherein the handlebar is comprised of a throttle button.

17. A method of using a motorized baby stroller device, the method comprising the following steps:
providing a motorized baby stroller device comprised of a body component, a seat, a frame, and a handle;
securing a user into the seat using a seatbelt;
pushing the motorized baby stroller device using the handle;
activating a battery-operated motor to assist in pushing the motorized baby stroller device; and
retracting a rooftop of the motorized baby stroller device.

18. The method of using a motorized baby stroller device of claim 17 further comprised of a step of collapsing the frame.

19. The method of using a motorized baby stroller device of claim 17 further comprised of a step of attaching an umbrella to the handle.

20. The method of using a motorized baby stroller device of claim 17 further comprised of a step of adjusting a direction of the stroller using a remote control.
